(19) United States
(12) Patent Application Publication
(10) Pub. No.: US 2017/0178572 A1
(43) Pub. Date: Jun. 22, 2017

(54) DISPLAY DRIVING METHOD AND DEVICE

(71) Applicant: BOE TECHNOLOGY GROUP CO., LTD., Beijing (CN)

(72) Inventors: Zhanjie MA, Beijing (CN); Tuo SUN, Beijing (CN)

(73) Assignee: BOE Technology Group Co., Ltd., Beijing (CN)

(21) Appl. No.: 15/301,751

(22) PCT Filed: Feb. 24, 2016
(86) PCT No.: PCT/CN2016/074463

§ 371 Date: Oct. 4, 2016

(30) Foreign Application Priority Data
Aug. 18, 2015 (CN) 201510507748.5

(51) Int. Cl. G09G 3/3266; G09G 3/3225

(52) U.S. Cl. CPC G09G 3/3266; G09G 3/3225; G09G 2300/043; G09G 2310/0262; G09G 2330/023

(57) ABSTRACT

The present disclosure discloses a display driving method and device. The method includes comparing a preset voltage difference with a voltage difference between a first data voltage and a second data voltage, where the first data voltage is a data voltage corresponding to a current row of pixel circuits, and the second data voltage is a data voltage corresponding to a next row of pixel circuits, and based on a comparison result, controlling whether to input a reference voltage to at least one pixel circuit in the next row of pixel circuits after inputting the first data voltage to the current row of pixel circuits and before inputting the second data voltage to the next row of pixel circuits.

### CROSS-REFERENCE TO RELATED APPLICATIONS

The preset application claims a priority of a Chinese patent application No. 201510507748.5 filed in China on Aug. 18, 2015, the disclosure of which is incorporated in its entirety by reference herein.

### TECHNICAL FIELD

The present disclosure relates to a field of Organic Light Emitting Diode (OLED) display device, and in particular, to a method and device for display driving.

### BACKGROUND

An OLED display device includes a source drive integrated circuit (IC), a gate drive IC, and an array substrate including pixel circuits that are arranged in N rows and M columns, where N and M are positive integers. The gate drive IC is connected with various pixel circuits in each row of pixel circuits through N scanning lines, and the source drive IC is connected with various pixel circuits in each column of pixel circuits through M data lines.

A display driving method for the OLED display device in the related art includes: under actions of clock signals, inputting, by the gate drive IC, a scan signal to each scanning line sequentially to turn on each row of pixel circuits in sequence, and synchronically inputting, by the source drive IC, a data voltage to each data line to provide the data voltage to each turned-on row of pixel circuits. In addition, after the source drive IC provides the data voltage to the current turned-on row of pixel circuits and before the source drive IC provides a data voltage to the next turned-on row of pixel circuits, the source drive IC further provides a reference voltage to the next row of pixel circuits. In this way, when the reference voltage is between the data voltage corresponding to the current row of pixel circuits and the data voltage corresponding to the next row of pixel circuits, the source drive IC may output the data voltage corresponding to the next row of pixel circuits based on the reference voltage. As compared with that the source drive IC outputs the data voltage corresponding to the next row of pixel circuits based on the data voltage corresponding to the current row of pixel circuits, a voltage difference is reduced.

In the course of presenting the present disclosure, the inventors have found at least the following problem exists in the related art: when both data voltages of two adjacent rows are larger than the reference voltage, or both data voltages of two adjacent rows are smaller than the reference voltage, a voltage difference that is needed for the source drive IC to output the data voltage corresponding to the next row of pixel circuits based on the reference voltage will be larger, in comparison with the source drive IC outputting the data voltage corresponding to the next row of pixel circuits based on the data voltage corresponding to the current row of pixel circuits. In such a case, the source drive IC will lose power consumption wastefully.

### SUMMARY

In order to reduce a power consumption of the source drive IC, embodiments of the present disclosure provide a display driving method and device. The technical solutions are discussed hereinafter.

In a first aspect, a display driving method is provided which includes: comparing a voltage difference between a first data voltage and a second data voltage with a preset voltage difference, where the first data voltage is a data voltage corresponding to a current row of pixel circuits, and the second data voltage is a data voltage corresponding to a next row of pixel circuits; and controlling, based on a comparison result, whether to input a reference voltage to at least one pixel circuit in the next row of pixel circuits after inputting the first data voltage to the current row of pixel circuits and before inputting the second data voltage to the next row of pixel circuits.

In a first embodiment of the first aspect, the step of comparing the voltage difference between the first data voltage and the second data voltage with the preset voltage difference includes: obtaining data voltages corresponding to two pixel circuits in the same column in the current row of pixel circuits and the next row of pixel circuits from the first data voltage and the second data voltage, respectively; calculating a voltage difference between the data voltages corresponding to the two pixel circuits in the same column; and comparing the voltage difference between the data voltages corresponding to the two pixel circuits in the same column with the preset voltage difference.

In combination with the first aspect and the first embodiment of the first aspect, in a second embodiment of the first aspect, the step of controlling, based on the comparison result, whether to input the reference voltage to at least one pixel circuit in the next row of pixel circuits after inputting the first data voltage to the current row of pixel circuits and before inputting the second data voltage to the next row of pixel circuits includes: when the voltage difference between the data voltages corresponding to the two pixel circuits in the same column is larger than the preset voltage difference, controlling to input the reference voltage to all pixel circuits of the next row of pixel circuits after inputting the first data voltage to the current row of pixel circuits and before inputting the second data voltage to the next row of pixel circuits; and when the voltage difference between the data voltages corresponding to the two pixel circuits in the same column is not larger than the preset voltage difference, controlling not to input the reference voltage to the next row of pixel circuits after inputting the first data voltage to the current row of pixel circuits and before inputting the second data voltage to the next row of pixel circuits.

In combination with the first aspect and the first embodiment of the first aspect, in a third embodiment of the first aspect, the step of controlling, based on the comparison result, whether to input the reference voltage to at least one pixel circuit in the next row of pixel circuits after inputting the first data voltage to the current row of pixel circuits and before inputting the second data voltage to the next row of pixel circuits includes: when the voltage difference between the data voltages corresponding to the two pixel circuits in the same column is larger than the preset voltage difference, controlling to input the reference voltage to pixel circuits of the next row of pixel circuits that are in a first area after inputting the first data voltage to the current row of pixel circuits and before inputting the second data voltage to the next row of pixel circuits; and where pixel circuits are divided into multiple areas in terms of columns, and each of the multiple areas includes at least one column of pixel circuits, and pixel circuits included in different areas belong to different columns, and the first area includes the column in which the two pixel circuits in the same column are located.

In a fourth embodiment of the first aspect, the preset voltage difference is (U1−U2)*K, where U1 is a maximum data voltage outputted by a source drive IC, U2 is a minimum data voltage outputted by the source drive IC, and K is a preset coefficient.

In a second aspect, a display driving device is provided which including: a comparison module configured to compare a voltage difference between a first data voltage and a second data voltage with a preset voltage difference, where the first data voltage is a data voltage corresponding to a current row of pixel circuits, and the second data voltage is a data voltage corresponding to a next row of pixel circuits; and a control module configured to, based on a comparison result, control whether to input a reference voltage to at least one pixel circuit in the next row of pixel circuits after inputting the first data voltage to the current row of pixel circuits and before inputting the second data voltage to the next row of pixel circuits.

In a first embodiment of the second aspect, the comparison module includes: an obtaining unit configured to obtain data voltages corresponding to two pixel circuits in the same column in the current row of pixel circuits and the next row of pixel circuits from the first data voltage and the second data voltage, respectively; a calculation unit configured to calculate a voltage difference between the data voltages corresponding to the two pixel circuits in the same column; and a comparison unit configured to compare the voltage difference between the data voltages corresponding to the two pixel circuits in the same column with the preset voltage difference.

In combination the second aspect and the first embodiment of the second aspect, in a second embodiment of the second aspect, the control module is configured to: when the voltage difference between the data voltages corresponding to the two pixel circuits in the same column is larger than the preset voltage difference, control to input the reference voltage to all pixel circuits of the next row of pixel circuits after inputting the first data voltage to the current row of pixel circuits and before inputting the second data voltage to the next row of pixel circuits; and when the voltage difference between the data voltages corresponding to the two pixel circuits in the same column is no larger than the preset voltage difference, control not to input the reference voltage to the next row of pixel circuits after inputting the first data voltage to the current row of pixel circuits and before inputting the second data voltage to the next row of pixel circuits.

In combination with the second aspect and the first embodiment of the second aspect, in a third embodiment of the second aspect, the pixel circuits are divided into multiple areas in terms of columns, and each of the multiple areas includes at least one column of pixel circuits, and pixel circuits included in different areas belong to different columns, and the multiple areas include a first area; the control module includes a plurality of control units, the plurality of control units are arranged corresponding to the multiple areas in a one-to-one manner and include a first control unit; the first control unit is configured to, when the voltage difference between the data voltages corresponding to the two pixel circuits in the same column is larger than the preset voltage difference, control to input the reference voltage to pixel circuits of the next row of pixel circuits in a first area after inputting the first data voltage to the current row of pixel circuits and before inputting the second data voltage to the next row of pixel circuits; and the first area includes the column in which the two pixel circuits in the same column are located, and the first control unit corresponds to the first area.

In a fourth embodiment of the second aspect, the preset voltage difference is (U1−U2)*K, where U1 is a maximum data voltage outputted by a source drive IC, U2 is a minimum data voltage outputted by the source drive IC, and K is a preset coefficient.

The advantages of the technical solutions of the embodiments of the present disclosure are as follow. The preset voltage difference is compared with the voltage difference between the first data voltage and the second data voltage, where the first data voltage is the data voltage corresponding to the current row of pixel circuits, and the second data voltage is the data voltage corresponding to the next row of pixel circuits; and whether to input a reference voltage to at least one pixel circuit in the next row of pixel circuits after inputting the first data voltage to the current row of pixel circuits and before inputting the second data voltage to the next row of pixel circuits, is controlled based on the comparison result. For example, when the comparison result shows that the voltage difference between the first data voltage and the second data voltage is larger than the preset voltage difference, and the reference voltage is between the first data voltage and the second data voltage, the power consumption of the source drive IC may be reduced by controlling to input the reference voltage to at least one pixel circuit in the next row of pixel circuits after inputting the first data voltage to the current row of pixel circuits and before inputting the second data voltage to the next row of pixel circuits. When the comparison result shows that the voltage difference between the first data voltage and the second data voltage is smaller than the preset voltage difference, the power consumption of the source drive IC may be reduced by controlling not to input the reference voltage to the next row of pixel circuits after inputting the first data voltage to the current row of pixel circuits and before inputting the second data voltage to the next row of pixel circuits.

### BRIEF DESCRIPTION OF THE DRAWINGS

In order to more clearly illustrate technical solutions of embodiments of the present disclosure, the drawings used in the description of the embodiments will be briefly discussed hereinafter. Obviously, the following figures are only some of the embodiments of the present disclosure, and one skilled in the art can derive other figures based on these figures without paying any creative labor.

FIG. 1 is a structural schematic diagram of an array substrate provided in the present disclosure;

FIG. 2 is a flowchart of a display driving method provided in at least some embodiments of the present disclosure;

FIG. 3 is a flowchart of a display driving method provided in at least some embodiments of the present disclosure;

FIG. 4 is a structural schematic diagram of a reference voltage input device provided in some embodiments of the present disclosure;

FIG. 5 is a structural schematic diagram of a reference voltage input device provided in some embodiments of the present disclosure;

FIG. 6 is a flowchart of a display driving method provided in at least some embodiments of the present disclosure;

FIG. 7 is a structural schematic diagram of a reference voltage input device provided in embodiments of the present disclosure;

FIG. 8 is a structural schematic diagram of a display driving device provided in at least some embodiments of the present disclosure; and

FIG. 9 is a structural schematic diagram of a display driving device provided in at least some embodiments of the present disclosure.

### DETAILED DESCRIPTION

To make objectives, technical solutions and advantages of the present disclosure more clear, the embodiments of the present disclosure will be further described in detail hereinafter in combination with the drawings.

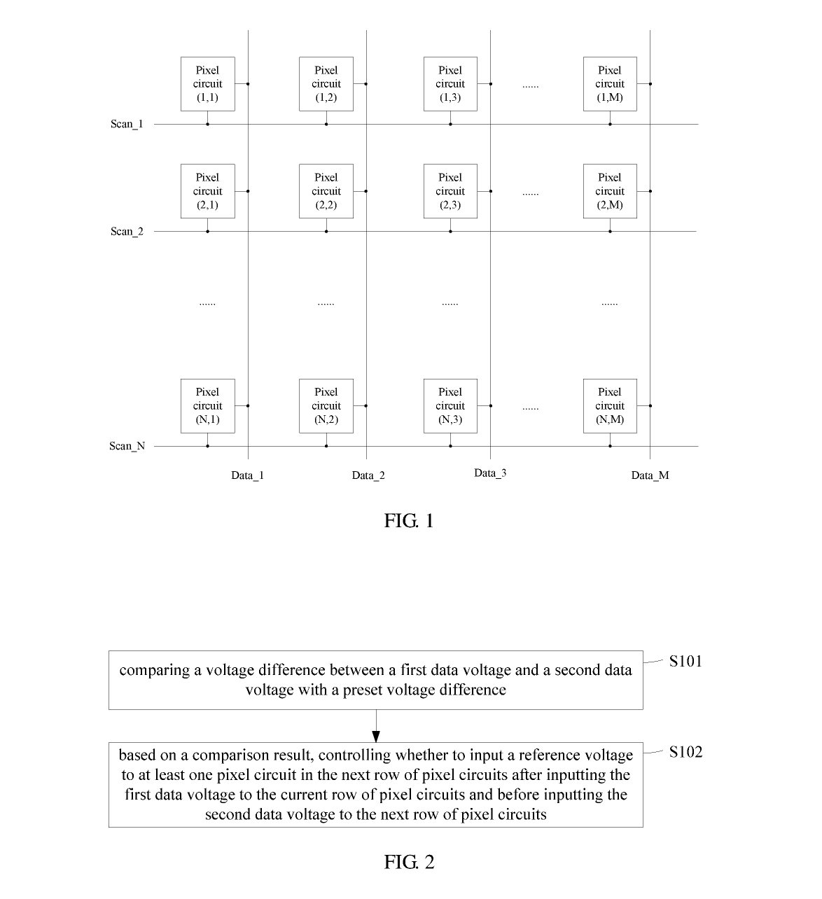

To facilitate understanding the technical solutions of the embodiments of the present disclosure, a display driving process for the OLED display device will be briefly discussed firstly. Referring to FIG. 1, assuming that an array substrate includes pixel circuits which are arranged in N rows and M columns, where N and M are positive integers, and each of the pixel circuits is to power a distinct LED. A gate drive IC is connected with various pixel circuits in each row of pixel circuits through N scanning lines, and the source drive IC is connected with various pixel circuits in each column of pixel circuits through M data lines. For example, a first row of pixel circuits include a total of M circuits, i.e., a circuit (1,1), a circuit (1,2), . . . , and a circuit (1, M), connected to a scanning line Scan_1. A first column of pixel circuits include a total of N circuits, i.e., the circuit (1,1), a circuit (2,1), . . . , and a circuit (N,1), connected to a data line Data_1. When the first row of pixel circuits are in operation, the gate drive IC inputs a scan signal to the scanning line Scan_1 to turn on the first row of pixel circuits, and the source drive IC inputs data voltages to the N data lines synchronically, to provide the data voltages to the first row of pixel circuits that are turned on. It should be noted that, structures of pixel circuits in the present embodiment are not limited, and may be the same as structures of pixel circuits in the related art.

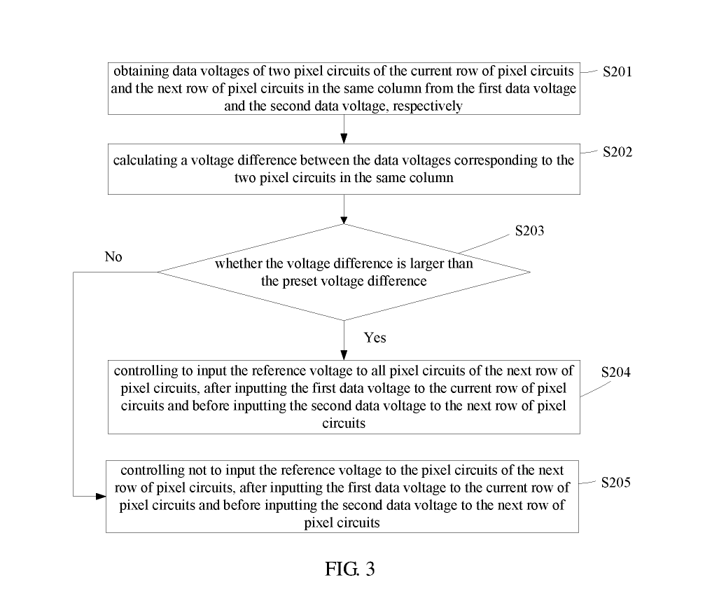

FIG. 2 shows a display driving method provided in at least some embodiments of the present disclosure. Referring to FIG. 2, the method includes the following steps.

Step S101 is to compare a voltage difference between a first data voltage and a second data voltage with a preset voltage difference.

The first data voltage is a data voltage corresponding to the current row of pixel circuits. The second data voltage is a data voltage corresponding to the next row of pixel circuits.

Specifically, the first data voltage includes the data voltage corresponding to each pixel circuit of the current row of pixel circuits, and the second data voltage includes the data voltage corresponding to each pixel circuit of the next row of pixel circuits. The Step S101 may include: firstly, obtaining data voltages of two pixel circuits of the current row of pixel circuits and the next row of pixel circuits in the same column from the first data voltage and the second data voltage, respectively; secondly, calculating a voltage difference between the data voltages of the two pixel circuits in the same column; and thirdly, comparing the voltage difference between the data voltages corresponding to the two pixel circuits in the same column with a preset voltage difference.

Step S102 is to, based on a comparison result, control whether to input a reference voltage to at least one pixel circuit in the next row of pixel circuits after inputting the first data voltage to the current row of pixel circuits and before inputting the second data voltage to the next row of pixel circuits.

The embodiments of the present disclosure compare the preset voltage difference with the voltage difference between the first data voltage and the second data voltage, where the first data voltage is the data voltage corresponding to the current row of pixel circuits, and the second data voltage is the data voltage corresponding to the next row of pixel circuits; and according to the comparison result, control whether to input a reference voltage to at least one pixel circuit in the next row of pixel circuits after inputting the first data voltage to the current row of pixel circuits and before inputting the second data voltage to the next row of pixel circuits.

For example, if the comparison result shows that the voltage difference between the first data voltage and the second data voltage is larger than the preset voltage difference, and the reference voltage is between the first data voltage and the second data voltage, the reference voltage is controlled to be input to at least one pixel circuit in the next row of pixel circuits after inputting the first data voltage to the current row of pixel circuits and before inputting the second data voltage to the next row of pixel circuits, thereby reducing the power consumption of the source drive IC. If the comparison result shows that the voltage difference between the first data voltage and the second data voltage is smaller than the preset voltage difference, the reference voltage is not input to the next row of pixel circuits after inputting the first data voltage to the current row of pixel circuits and before inputting the second data voltage to the next row of pixel circuits, so as to reduce the power consumption of the source drive IC. In case that the comparison result shows that the voltage difference between the first data voltage and the second data voltage is smaller than the preset voltage difference, two cases may exist, which are (1) both the first data voltage and the second data voltage are larger than or smaller than the reference voltage, at this point, the power consumption of the source drive IC may be reduced significantly by not inputting the reference voltage to the next row of pixel circuits after inputting the first data voltage to the current row of pixel circuits and before inputting the second data voltage to the next row of pixel circuits; and (2) the reference voltage is between the first data voltage and the second data voltage, at this point, since the voltage difference between the first data voltage and the second data voltage is smaller than the preset voltage difference, thus the power consumption of the source drive IC will not be increased dramatically due to not inputting the reference voltage to the next row of pixel circuits after inputting the first data voltage to the current row of pixel circuits and before inputting the second data voltage to the next row of pixel circuits. The preset voltage difference and the reference voltage may be set according to actual conditions.

FIG. 3 shows a display driving method provided in at least some embodiments of the present disclosure. In the present embodiment, one manner for controlling inputting the reference voltage to the pixel circuits will be described in detail. Referring to FIG. 3, the method includes the following steps.

Step S201 is to obtain data voltages of two pixel circuits of the current row of pixel circuits and the next row of pixel circuits in the same column from the first data voltage and the second data voltage, respectively.

The first data voltage is the data voltage corresponding to the current row of pixel circuits, and the second data voltage is the data voltage corresponding to the next row of pixel circuits. The first data voltage includes the data voltage corresponding to each pixel circuit of the current row of pixel circuits, and the second data voltage includes the data voltage corresponding to each pixel circuit of the next row of pixel circuits.

The source drive IC inputs data voltages to each row of pixel circuits sequentially. For example, the source drive IC inputs a data voltage to the current row of pixel circuits firstly, and after a certain period of time, continues to input a data voltage to the next row of pixel circuits. Specifically, before the source drive IC inputs the data voltage to the current row of pixel circuits or when the source drive IC inputs the data voltage to the current row of pixel circuits, data voltages of two pixel circuits of the current row of pixel circuits and the next row of pixel circuits in the same column are obtained from the first data voltage and the second data voltage, respectively.

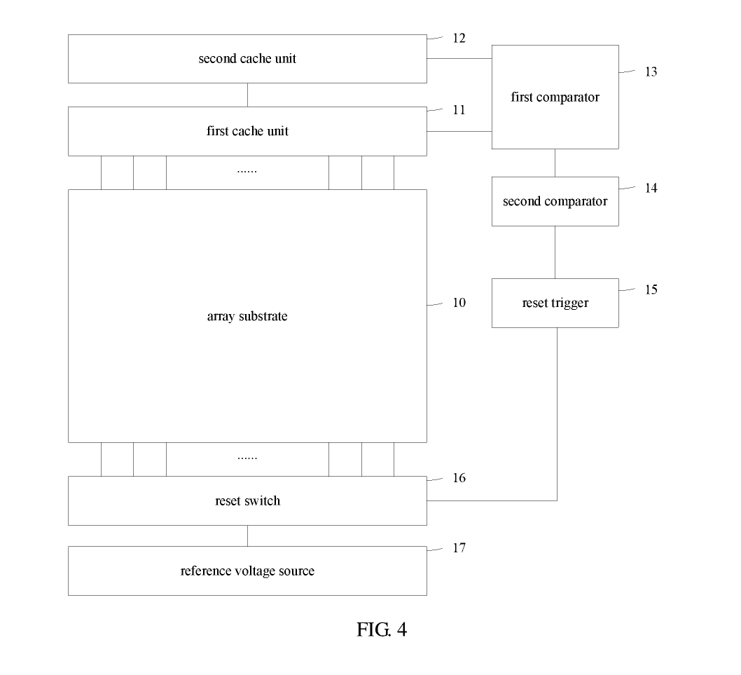

In implementation, referring to FIG. 4, two cache units, i.e., a first cache unit 11 and a second cache unit 12, may be arranged in the source drive IC. The first cache unit 11 stores a data voltage corresponding to each pixel circuit of the current row of pixel circuits. The second cache unit 12 stores a data voltage corresponding to each pixel circuit of the next row of pixel circuits. The first cache unit 11 is connected with each of data lines of the array substrate 10. The second cache unit 12 is connected with the first cache unit 11. A process for updating data in the first cache unit 11 and the second cache unit 12 includes: inputting updated data to the second cache unit 12 for storage, and inputting data stored previously in the second cache unit 12 to the first cache unit 11 to replace data stored previously in the first cache unit 11.

Step S202 is to calculate a voltage difference between the data voltages corresponding to the two pixel circuits in the same column.

Specifically, a first comparator 13 may be used to calculate the voltage difference between the data voltages corresponding to the two pixel circuits in the same column. The first comparator 13 may be connected with the first cache unit 11 and the second cache unit 12.

Step S203 is to compare the voltage difference between the data voltages corresponding to the two pixel circuits in the same column with a preset voltage difference.

If the voltage difference between the data voltages corresponding to the two pixel circuits in the same column is larger than the preset voltage difference, Step S204 is performed; if the voltage difference between the data voltages corresponding to the two pixel circuits in the same column is not larger than the preset voltage difference, Step S205 is performed.

The preset voltage difference may be (U1−U2)*K, where U1 is a maximum data voltage outputted by the source drive IC, U2 is a minimum data voltage outputted by the source drive IC, and the K is a preset coefficient. As an option, the K may be equal to 0.5.

Specifically, a second comparator 14 may be used to compare the voltage difference between the data voltages corresponding to the two pixel circuits in the same column with the preset voltage difference. The second comparator 14 is connected with the first comparator 13. If a voltage difference between data voltages corresponding to two pixel circuits in at least one column of the M columns of pixel circuits is larger than the preset voltage difference, Step S204 is performed. Otherwise, if a voltage difference between data voltages corresponding to two pixel circuits in any column of the M columns of pixel circuits is not larger than the preset voltage difference, Step S205 is performed.

Step S204 is to control inputting the reference voltage to all pixel circuits of the next row of pixel circuits after inputting the first data voltage to the current row of pixel circuits and before inputting the second data voltage to the next row of pixel circuits.

The first data voltage is inputted to the current row of pixel circuits firstly, the reference voltage is then inputted to all pixel circuits of the next row of pixel circuits, and the second data voltage is inputted to the next row of pixel circuits finally.

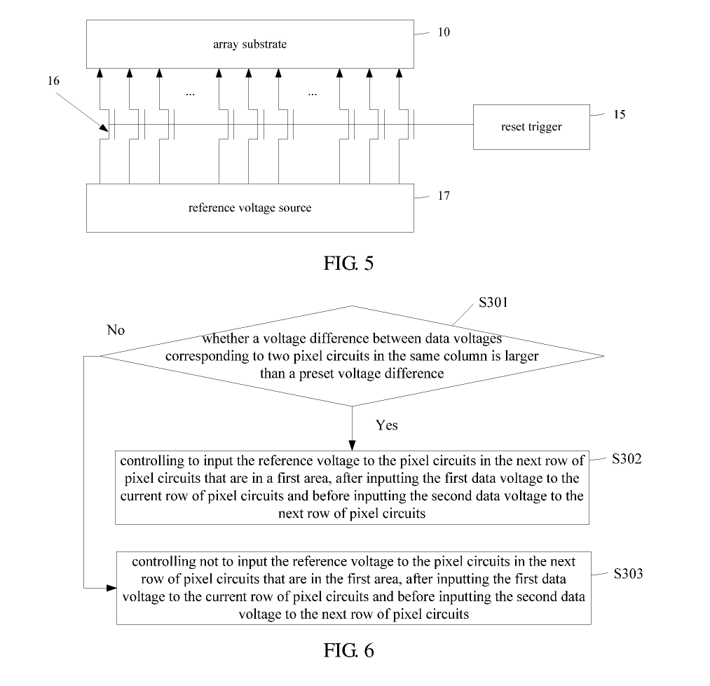

In implementation, a reset trigger 15 may be used to control inputting the reference voltage to all pixel circuits of the next row of pixel circuits. The reset trigger 15 may be implemented by a pulse signal generator. The reference voltage may be provided by the source drive IC, or be provided by a power-source module of the OLED display device. The reset trigger 15 is electrically connected with the second comparator 14. If a comparison result from the second comparator 14 shows that the voltage difference between data voltages corresponding to two pixel circuits in at least one column is larger than the preset voltage difference, the reset trigger 15 is triggered to work. The reset trigger 15 sends out a pulse signal with a certain width. A generation time for the pulse signal is after writing a data voltage to the current row is completed and before writing a data voltage to the next row is started. On one hand, the pulse signal is used to turn on the next row of pixel circuits; on another hand, the pulse signal triggers a plurality of reset switches 16 synchronously. Referring to FIG. 5, each data line corresponds to one reset switch 16, and different data lines correspond to different reset switches 16. The reset switches 16 may be thin film transistors. A gate control signal of each thin film transistor is the pulse signal outputted by the reset trigger 15, and a source electrode and a drain electrode of the thin film transistor are connected with a reference voltage source 17 and the data line corresponding to the transistor, respectively. The reference voltage source 17 outputs the reference voltage. The reference voltage may be a direct-current voltage having an amplitude (U1−U2)*k.

When the pulse signal controls the thin film transistor to be turned on, the reference voltage inputted to the thin film transistor is inputted via the thin film transistor to the data line in the array substrate 10, and charge information kept in a capacitor of the next row of pixel circuits in the data line is transformed into a reset reference direct-current voltage. Meanwhile, data corresponding to the next row of pixel circuits stored in the second cache unit 12 is written into the first cache unit 11. In this way, before the data corresponding to the next row of pixel circuits is written into the array substrate 10, the data lines have been inputted with reference potential signals.

By controlling to input the reference voltage to all pixel circuits in the next row of pixel circuits after inputting the first data voltage to the current row of pixel circuits and before inputting the second data voltage to the next row of pixel circuits when the voltage difference between data voltages corresponding to two pixel circuits in the same column is larger than the preset voltage difference, the reference voltage may be inputted to all pixel circuits in the next row of pixel circuits when the voltage difference between data voltages corresponding to two pixel circuits in at least one column is larger than the preset voltage difference. In this way, one reset trigger 15 may be arranged for all data lines, thereby simplifying line arrangement.

Step S205 is to control not to input the reference voltage to the next row of pixel circuits after inputting the first data voltage to the current row of pixel circuits and before inputting the second data voltage to the next row of pixel circuits.

In case that the voltage difference between data voltages corresponding to two pixel circuits in all of the M columns is not larger than the preset voltage difference, the reference voltage is not inputted to the next row of pixel circuits.

In one embodiment of the present disclosure, the preset voltage difference is compared with the voltage difference between the first data voltage and the second data voltage, where the first data voltage is the data voltage corresponding to the current row of pixel circuits, and the second data voltage is the data voltage corresponding to the next row of pixel circuits; and whether to input a reference voltage to at least one pixel circuit in the next row of pixel circuits after inputting the first data voltage to the current row of pixel circuits and before inputting the second data voltage to the next row of pixel circuits, is controlled based on the comparison result.

For example, if the comparison result shows that the voltage difference between the first data voltage and the second data voltage is larger than the preset voltage difference, and the reference voltage is between the first data voltage and the second data voltage, the reference voltage is controlled to be input to the at least one pixel circuit in the next row of pixel circuits after inputting the first data voltage to the current row of pixel circuits and before inputting the second data voltage to the next row of pixel circuits, thereby reducing the power consumption of the source drive IC. If the comparison result shows that the voltage difference between the first data voltage and the second data voltage is smaller than the preset voltage difference, it is controlled not to input the reference voltage to the next row of pixel circuits after inputting the first data voltage to the current row of pixel circuits and before inputting the second data voltage to the next row of pixel circuits, so as to reduce the power consumption of the source drive IC. In case that the comparison result shows that the voltage difference between the first data voltage and the second data voltage is smaller than the preset voltage difference, two cases may exist, which are (1) both the first data voltage and the second data voltage are larger than or smaller than the reference voltage, at this point, the power consumption of the source drive IC may be reduced significantly by not inputting the reference voltage to the next row of pixel circuits after inputting the first data voltage to the current row of pixel circuits and before inputting the second data voltage to the next row of pixel circuits; and (2) the reference voltage is between the first data voltage and the second data voltage, at this point, since the voltage difference between the first data voltage and the second data voltage is smaller than the preset voltage difference, thus, the power consumption of the source drive IC may be not increased dramatically by not inputting the reference voltage to the next row of pixel circuits after inputting the first data voltage to the current row of pixel circuits and before inputting the second data voltage to the next row of pixel circuits. The preset voltage difference and the reference voltage may be set according to actual conditions.

FIG. 6 shows a display driving method provided in at least some embodiments of the present disclosure. A fashion to control the reference voltage to be inputted to the pixel circuits provided in the present embodiment is different from the method provided in the embodiment shown in FIG. 3. In the embodiment shown in FIG. 3, in case that the voltage difference between data voltages corresponding to two pixel circuits in at least one of the M columns is larger than the preset voltage difference, the reference voltage is inputted to all pixel circuits of the next row of pixel circuits. In the present embodiment, in case that the voltage difference between data voltages corresponding to two pixel circuits in one of the columns is larger than the preset voltage difference, the reference voltage is inputted to pixel circuits that are in an area where the one column is located, in the next row of pixel circuits. The area where the one column is located may include at least one column of pixel circuits.

Referring to FIG. 6, the method includes the following steps.

Step S301 is to compare a voltage difference between a first data voltage and a second data voltage with a preset voltage difference.

If the voltage difference between the data voltages corresponding to the two pixel circuits in the same column is larger than the preset voltage difference, Step S302 is performed; if the voltage difference between the data voltages corresponding to the two pixel circuits in the same column is not larger than the preset voltage difference, Step S303 is performed.

The step S301 may include Step S201-Step S203, which are not repeated herein.

Step S302 is to control to input the reference voltage to pixel circuits in a first area, in the next row of pixel circuits, after inputting the first data voltage to the current row of pixel circuits and before inputting the second data voltage to the next row of pixel circuits.

The pixel circuits are divided in terms of columns into multiple areas, each of which includes at least one column of pixel circuits. Pixel circuits included in different areas belong to different columns. The first area includes the column in which the two pixel circuits in the same column are located.

As an option, the number of columns included in each area may be the same. For example, each area may include one column of pixel circuits. The number of columns included in each area may also be different. For example, some of the areas include two columns of pixel circuits, and others of the areas include three columns of pixel circuits.

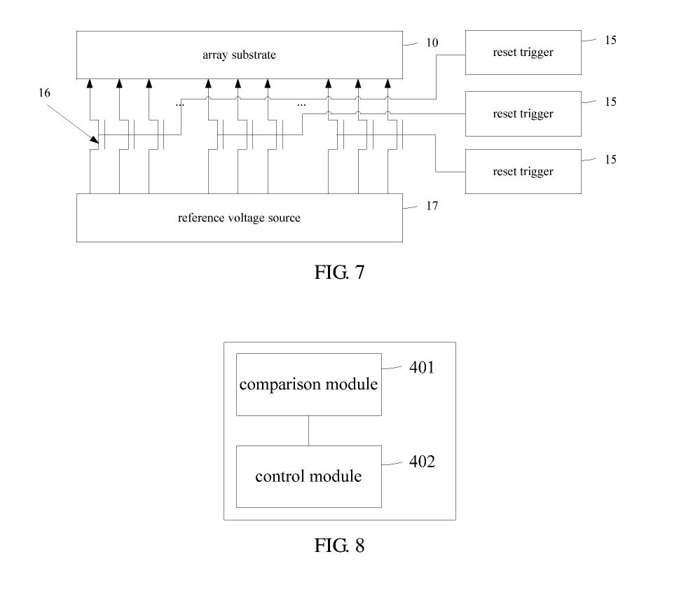

In implementation, multiple reset triggers 15 may be arranged, each of which corresponds to one of the areas, and different reset triggers 15 correspond to different areas. A pulse signal output terminal of each reset trigger 15 is connected with gate electrodes of the reset switches 16 arranged in the area corresponding to the reset trigger 15. Referring to FIG. 7, assuming that each area includes three columns of pixel circuits, one reset trigger 15 is arranged for every three data lines, and each reset trigger 15 is connected with reset switches 16 arranged on the three data lines. It should be noted that the example that each area includes three columns of pixel circuits is only exemplary, and the number of columns of pixel circuits included in each area is not limited thereto.

By controlling to input the reference voltage to the pixel circuits of the next row of pixel circuits that are within in the first area after inputting the first data voltage to the current row of pixel circuits and before inputting the second data voltage to the next row of pixel circuits when the voltage difference between data voltages corresponding to two pixel circuits in the same column is larger than the preset voltage difference, the reference voltage may be provided to the pixel circuits included in the first area during inputting data voltages of two adjacent rows in case that the voltage difference between the data voltages of the two adjacent rows in at least one column of pixel circuits included in the first area is larger than the preset voltage difference. In this way, the areas of the pixel circuits may be partitioned according to actual requirements and a corresponding number of reset triggers 15 may be arranged with respect to the number of the partitioned areas.

Step S303 is to control not to input the reference voltage to the pixel circuits located in the first area, in the next row of pixel circuits after inputting the first data voltage to the current row of pixel circuits and before inputting the second data voltage to the next row of pixel circuits.

In one embodiment of the present disclosure, the preset voltage difference is compared with the voltage difference between the first data voltage and the second data voltage, where the first data voltage is the data voltage corresponding to the current row of pixel circuits, and the second data voltage is the data voltage corresponding to the next row of pixel circuits; and whether to input the reference voltage to at least one pixel circuit in the next row of pixel circuits after inputting the first data voltage to the current row of pixel circuits and before inputting the second data voltage to the next row of pixel circuits, is controlled based on the comparison result.

For example, if the comparison result shows that the voltage difference between the first data voltage and the second data voltage is larger than the preset voltage difference, and the reference voltage is between the first data voltage and the second data voltage, the power consumption of the source drive IC may be reduced by inputting the reference voltage to the at least one pixel circuit in the next row of pixel circuits after inputting the first data voltage to the current row of pixel circuits and before inputting the second data voltage to the next row of pixel circuits. If the comparison result shows that the voltage difference between the first data voltage and the second data voltage is smaller than the preset voltage difference, the power consumption of the source drive IC may be reduced by not inputting the reference voltage to the pixel circuits in the next row of pixel circuits after inputting the first data voltage to the current row of pixel circuits and before inputting the second data voltage to the next row of pixel circuits. When the comparison result shows that the voltage difference between the first data voltage and the second data voltage is smaller than the preset voltage difference, two cases may exist, which are (1) both the first data voltage and the second data voltage are larger than or smaller than the reference voltage, at this point, the power consumption of the Source Drive IC may be reduced significantly by not inputting the reference voltage to the next row of pixel circuits after inputting the first data voltage to the current row of pixel circuits and before inputting the second data voltage to the next row of pixel circuits; and (2) the reference voltage is between the first data voltage and the second data voltage, at this time, since the voltage difference between the first data voltage and the second data voltage is smaller than the preset voltage difference, thus the power consumption of the source drive IC may be not increased dramatically by not inputting the reference voltage to the next row of pixel circuits after inputting the first data voltage to the current row of pixel circuits and before inputting the second data voltage to the next row of pixel circuits. The preset voltage difference and the reference voltage may be set according to actual conditions.

FIG. 8 shows a display driving device provided in some embodiments of the present disclosure. The device may be applied to the methods provided in the embodiments shown in FIG. 2, FIG. 3 or FIG. 6, and may be arranged in an OLED display device. Referring to FIG. 8, the device includes a comparison module 401 and a control module 402.

The comparison module 401 is configured to compare a voltage difference between a first data voltage and a second data voltage with a preset voltage difference. The first data voltage is the data voltage corresponding to the current row of pixel circuits. The second data voltage is the data voltage corresponding to the next row of pixel circuits.

Referring back to FIG. 4, the comparison module 401 may include the first cache unit 11, the second cache unit 12, the first comparator 13 and the second comparator 14 shown in FIG. 4.

The control module 402 is configured to, according to the comparison result, control whether to input the reference voltage to at least one pixel circuit in the next row of pixel circuits after inputting the first data voltage to the current row of pixel circuits and before inputting the second data voltage to the next row of pixel circuits.

Referring back to FIG. 4, the control module 402 may include the reset trigger 15, the reset switch 16 and the reference voltage source 17 shown in FIG. 4.

In one embodiments of the present disclosure, the preset voltage difference is compared with the voltage difference between the first data voltage and the second data voltage, where the first data voltage is the data voltage corresponding to the current row of pixel circuits, and the second data voltage is the data voltage corresponding to the next row of pixel circuits; and whether to input a reference voltage to at least one pixel circuit in the next row of pixel circuits after inputting the first data voltage to the current row of pixel circuits and before inputting the second data voltage to the next row of pixel circuits, is controlled based on the comparison result.

For example, if the comparison result shows that the voltage difference between the first data voltage and the second data voltage is larger than the preset voltage difference, and the reference voltage is between the first data voltage and the second data voltage, the power consumption of the source drive IC may be reduced by controlling to input the reference voltage to the at least one pixel circuit in the next row of pixel circuits after inputting the first data voltage to the current row of pixel circuits and before inputting the second data voltage to the next row of pixel circuits. If the comparison result shows that the voltage difference between the first data voltage and the second data voltage is smaller than the preset voltage difference, the power consumption of the source drive IC may be reduced by controlling not to input the reference voltage to the next row of pixel circuits after inputting the first data voltage to the current row of pixel circuits and before inputting the second data voltage to the next row of pixel circuits. In case that the comparison result shows that the voltage difference between the first data voltage and the second data voltage is smaller than the preset voltage difference, two cases may exist, which are (1) both the first data voltage and the second data voltage are larger than or smaller than the reference voltage, at this point, the power consumption of the source drive IC may be reduced significantly by not inputting the reference voltage to the next row of pixel circuits after inputting the first data voltage to the current row of pixel circuits and before inputting the second data voltage to the next row of pixel circuits; and (2) the reference voltage is between the first data voltage and the second data voltage, at this point, since the voltage difference between the first data voltage and the second data voltage is smaller than the preset voltage difference, thus the power consumption of the source drive IC may be not increased dramatically by not inputting the reference voltage to the next row of pixel circuits after inputting the first data voltage to the current row of pixel circuits and before inputting the second data voltage to the next row of pixel circuits The preset voltage difference and the reference voltage may be set according to actual conditions.

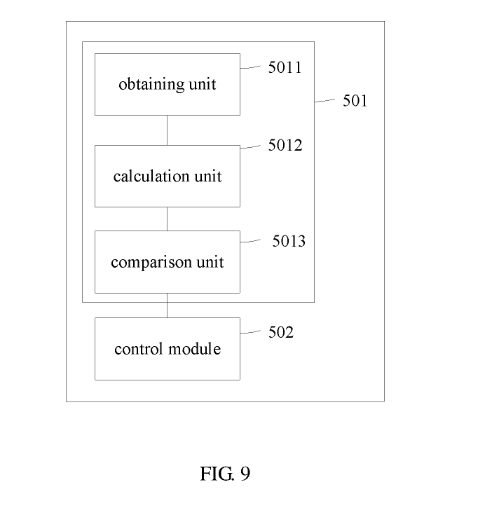

FIG. 9 shows a display driving device provided in at least some embodiments of the present disclosure. The device may be applied to the methods provided in the embodiments shown in FIG. 2, FIG. 3 or FIG. 6, and may be arranged in the OLED display device. Referring to FIG. 9, the device includes a comparison module 501 and a control module 502.

The comparison module 501 may include: an obtaining unit 5011 for obtaining data voltages of two pixel circuits of the current row of pixel circuits and the next row of pixel circuits in the same column from the first data voltage and the second data voltage, respectively; a calculation unit 5012 for calculating a voltage difference between the data voltages of the two pixel circuits in the same column; and a comparison unit 5013 for comparing the voltage difference between the data voltages corresponding to the two pixel circuits in the same column with a preset voltage difference.

Referring back to FIG. 4, the obtaining unit 5011 may use the first cache unit 11 and the second cache unit 12 shown in FIG. 4; the calculation unit 5012 may use the first comparator 13 shown in FIG. 4; and the comparator unit 5013 may use the second comparator 14 shown in FIG. 4.

In an optional first embodiment, the control module 502 may be used to, in case that the voltage difference between the data voltages corresponding to the two pixel circuits in the same column is larger than the preset voltage difference, control to input the reference voltage to all pixel circuits of the next row of pixel circuits after inputting the first data voltage to the current row of pixel circuits and before inputting the second data voltage to the next row of pixel circuits; in case that the voltage difference between the data voltages corresponding to the two pixel circuits in the same column is not larger than the preset voltage difference, control not to input the reference voltage to the next row of pixel circuits after inputting the first data voltage on the current row of pixel circuits and before inputting the second data voltage to the next row of pixel circuits.

Referring back to FIG. 5, the control module 502 may include the reset trigger 15 and the reset switch 16 shown in FIG. 5.

The pixel circuits may be divided into multiple areas in terms of columns, and each of the areas includes at least one column of pixel circuits, and pixel circuits included in different areas belong to different columns. Based on this, in an optional second embodiment, the control module 502 may include a plurality of control units which are arranged corresponding to the multiple areas in a one-to-one manner. The first control unit may be used to, in case that the voltage difference between the data voltages corresponding to the two pixel circuits in the same column is larger than the preset voltage difference, control to input the reference voltage to the pixel circuits in the next row of pixel circuits located in the first area after inputting the first data voltage to the current row of pixel circuits and before inputting the second data voltage to the next row of pixel circuits. The first area includes the column in which the two pixel circuits in the same column are located and the first control unit corresponds to the first area.

Referring back to FIG. 7, one control unit may include one reset trigger 15 shown in FIG. 7 and at least one reset switch 16 connected with the reset trigger 15.

The preset voltage difference is (U1−U2)*0.5, where U1 is a maximum data voltage outputted by the source drive IC, and U2 is a minimum data voltage outputted by the source drive IC.

In one embodiments of the present disclosure, the preset voltage difference is compared with the voltage difference between the first data voltage and the second data voltage, where the first data voltage is the data voltage corresponding to the current row of pixel circuits, and the second data voltage is the data voltage corresponding to the next row of pixel circuits; and whether to input the reference voltage to at least one pixel circuit in the next row of pixel circuits after inputting the first data voltage to the current row of pixel circuits and before inputting the second data voltage to the next row of pixel circuits, is controlled based on the comparison result.

For example, if the comparison result shows that the voltage difference between the first data voltage and the second data voltage is larger than the preset voltage difference, and the reference voltage is between the first data voltage and the second data voltage, the power consumption of the source drive IC may be reduced by controlling to input the reference voltage to the at least one pixel circuit in the next row of pixel circuits after inputting the first data voltage to the current row of pixel circuits and before inputting the second data voltage to the next row of pixel circuits. If the comparison result shows that the voltage difference between the first data voltage and the second data voltage is smaller than the preset voltage difference, the power consumption of the source drive IC may be reduced by controlling not to input the reference voltage to the next row of pixel circuits after inputting the first data voltage to the current row of pixel circuits and before inputting the second data voltage to the next row of pixel circuits,. When the comparison result shows that the voltage difference between the first data voltage and the second data voltage is smaller than the preset voltage difference, two cases may exist, which are (1) both the first data voltage and the second data voltage are larger than or smaller than the reference voltage, at this point, the power consumption of the source drive IC may be reduced significantly by not inputting the reference voltage to the next row of pixel circuits after inputting the first data voltage to the current row of pixel circuits and before inputting the second data voltage to the next row of pixel circuits; and (2) the reference voltage is between the first data voltage and the second data voltage, at this point, since the voltage difference between the first data voltage and the second data voltage is smaller than the preset voltage difference, thus the power consumption of the source drive IC may be not increased dramatically by controlling not to input the reference voltage to the next row of pixel circuits after inputting the first data voltage to the current row of pixel circuits and before inputting the second data voltage to the next row of pixel circuits. The preset voltage difference and the reference voltage may be set according to actual conditions.

It should be noted that the display driving device provided in the above embodiments are exemplified only by the above module divisions for various functions when implementing display driving. However, in actual applications, the functions may be distributed to be done by different modules according to requirements. That is, inner structures of the device may be divided into different functional modules to implement all or part of the above functions described above. In addition, the display driving device and method provided in the above embodiments share the same concept. Details of implementation process thereof are given in the process embodiment, and are not repeated herein.

A sequence of the above embodiments of the present disclosure is only for the purpose of description, but does not represent priority levels of the embodiments.

It may be easily understood by those skilled in the art that all of parts of steps in the above embodiments may be preformed either by hardware or by instructing relevant hardware using programs. The programs may be stored a computer readable storage medium which may be a read-only memory, a magnetic disk, a compact disk or the like.

The above descriptions are only preferred embodiments of the present disclosure, but are not used to limit the present disclosure. All modifications, equivalences and improvements made in the spirit and principle of the present disclosure are included in the protection scope of the present disclosure.

1. A display driving method, comprising:
comparing a voltage difference between a first data voltage and a second data voltage with a preset voltage difference; wherein the first data voltage is a data voltage corresponding to a current row of pixel circuits, and the second data voltage is a data voltage corresponding to a next row of pixel circuits; and
controlling, based on a comparison result, whether to input a reference voltage to at least one pixel circuit in the next row of pixel circuits after inputting the first data voltage to the current row of pixel circuits and before inputting the second data voltage to the next row of pixel circuits.

2. The method according to claim 1, wherein the step of comparing the voltage difference between the first data voltage and the second data voltage with the preset voltage difference comprising:
obtaining data voltages corresponding to two pixel circuits in the same column in the current row of pixel circuits and the next row of pixel circuits from the first data voltage and the second data voltage, respectively;
calculating a voltage difference between the data voltages corresponding to the two pixel circuits in the same column; and
comparing the voltage difference between the data voltages corresponding to the two pixel circuits in the same column with the preset voltage difference.

3. The method according to claim 2, wherein, the step of controlling, based on the comparison result, whether to input the reference voltage to at least one pixel circuit in the next row of pixel circuits after inputting the first data voltage to the current row of pixel circuits and before inputting the second data voltage to the next row of pixel circuits comprising:
when the voltage difference between the data voltages corresponding to the two pixel circuits in the same column is larger than the preset voltage difference, controlling to input the reference voltage to all pixel circuits of the next row of pixel circuits after inputting the first data voltage to the current row of pixel circuits and before inputting the second data voltage to the next row of pixel circuits; and
when the voltage difference between the data voltages corresponding to the two pixel circuits in the same column is not larger than the preset voltage difference, controlling not to input the reference voltage to the next row of pixel circuits after inputting the first data voltage to the current row of pixel circuits and before inputting the second data voltage to the next row of pixel circuits.

4. The method according to claim 2, wherein, the step of controlling, based on the comparison result, whether to input the reference voltage to at least one pixel circuit in the next row of pixel circuits after inputting the first data voltage to the current row of pixel circuits and before inputting the second data voltage to the next row of pixel circuits comprising:
when the voltage difference between the data voltages corresponding to the two pixel circuits in the same column is larger than the preset voltage difference, controlling to input the reference voltage to pixel circuits of the next row of pixel circuits that are located in a first area, after inputting the first data voltage to the current row of pixel circuits and before inputting the second data voltage to the next row of pixel circuits;
wherein all pixel circuits are divided into multiple areas in terms of columns, and each of the multiple areas includes at least one column of pixel circuits; and pixel circuits included in different areas belong to different columns, and the first area comprises the column in which the two pixel circuits in the same column are located.

5. The method according to claim 1, wherein the preset voltage difference is (U1−U2)*K, where U1 is a maximum data voltage outputted by a source driving integrated circuit, U2 is a minimum data voltage outputted by the source driving integrated circuit, and K is a preset coefficient.

6. A display driving device, comprising:
a comparison module configured to compare a voltage difference between a first data voltage and a second data voltage with a preset voltage difference, wherein the first data voltage is a data voltage corresponding to a current row of pixel circuits, and the second data voltage is a data voltage corresponding to a next row of pixel circuits; and
a control module configured to, based on a comparison result, control whether to input a reference voltage to at least one pixel circuit in the next row of pixel circuits after inputting the first data voltage to the current row of pixel circuits and before inputting the second data voltage to the next row of pixel circuits.

7. The device according to claim 6, wherein the comparison module comprises:
an obtaining unit configured to obtain data voltages corresponding to two pixel circuits in the same column in the current row of pixel circuits and the next row of pixel circuits from the first data voltage and the second data voltage, respectively;
a calculation unit configured to calculate a voltage difference between the data voltages corresponding to the two pixel circuits in the same column; and
a comparison unit configured to compare the voltage difference between the data voltages corresponding to the two pixel circuits in the same column with the preset voltage difference.

8. The device according to claim 7, wherein the control module is configured to,
when the voltage difference between the data voltages corresponding to the two pixel circuits in the same column is larger than the preset voltage difference, control to input the reference voltage to all pixel circuits of the next row of pixel circuits after inputting the first data voltage to the current row of pixel circuits and before inputting the second data voltage to the next row of pixel circuits; and
when the voltage difference between the data voltages corresponding to the two pixel circuits in the same column is not larger than the preset voltage difference, control not to input the reference voltage to the next row of pixel circuits after inputting the first data voltage to the current row of pixel circuits and before inputting the second data voltage to the next row of pixel circuits.

9. The device according to claim 7, wherein all pixel circuits are divided into multiple areas in terms of columns, and each of the multiple areas includes at least one column of pixel circuits, and pixel circuits included in different areas belong to different columns, and the multiple areas comprise a first area;
wherein the control module comprises a plurality of control units; the plurality of control units correspond to the multiple areas in a one-to-one manner and comprise a first control unit:
wherein the first control unit is configured to, when the voltage difference between the data voltages corresponding to the two pixel circuits in the same column is larger than the preset voltage difference, control to input the reference voltage to pixel circuits of the next row of pixel circuits that are in the first area after inputting the first data voltage to the current row of pixel circuits and before inputting the second data voltage to the next row of pixel circuits; and
wherein the first area comprises the column in which the two pixel circuits in the same column are located, and the first control unit corresponds to the first area.

10. The device according to claim 6, wherein the preset voltage difference is (U1−U2)*K, where U1 is a maximum data voltage outputted by a source driving integrated circuit, U2 is a minimum data voltage outputted by the source driving integrated circuit, and K is a preset coefficient.

11. The method according to claim 2, wherein the preset voltage difference is (U1−U2)*K, where U1 is a maximum data voltage outputted by a source driving integrated circuit, U2 is a minimum data voltage outputted by the source driving integrated circuit, and K is a preset coefficient.

12. The method according to claim 3, wherein the preset voltage difference is (U1−U2)*K, where U1 is a maximum data voltage outputted by a source driving integrated circuit, U2 is a minimum data voltage outputted by the source driving integrated circuit, and K is a preset coefficient.

13. The method according to claim 4, wherein the preset voltage difference is (U1−U2)*K, where U1 is a maximum data voltage outputted by a source driving integrated circuit, U2 is a minimum data voltage outputted by the source driving integrated circuit, and K is a preset coefficient.

14. The device according to claim 7, wherein the preset voltage difference is (U1−U2)*K, where U1 is a maximum data voltage outputted by a source driving integrated circuit, U2 is a minimum data voltage outputted by the source driving integrated circuit, and K is a preset coefficient.

15. The device according to claim 8, wherein the preset voltage difference is (U1−U2)*K, where U1 is a maximum data voltage outputted by a source driving integrated circuit, U2 is a minimum data voltage outputted by the source driving integrated circuit, and K is a preset coefficient.

16. The device according to claim 9, wherein the preset voltage difference is (U1−U2)*K, where U1 is a maximum data voltage outputted by a source driving integrated circuit, U2 is a minimum data voltage outputted by the source driving integrated circuit, and K is a preset coefficient.
